(19) United States
(12) Patent Application Publication
(10) Pub. No.: US 2026/0198459 A1
(43) Pub. Date: Jul. 16, 2026

(54) Interchangeable Pet Collar and Leash System

(71) Applicant: Veronica A. Nolan, Akron, PA (US)

(72) Inventor: Veronica A. Nolan, Akron, PA (US)

(21) Appl. No.: 19/020,793

(22) Filed: Jan. 14, 2025

(51) Int. Cl. A01K 27/00

(52) U.S. Cl. CPC A01K 27/005; A01K 27/001; A01K 27/003; A01K 27/006

(57) ABSTRACT

The present disclosure provides an interchangeable animal collar and leash system. The system includes a base strap, a plurality of fasteners positioned along the base strap, a strap connector attached to the base strap, an overlaying strap attached to the base strap, and a ring connector attached to the overlaying strap. The system components are designed to be interchangeable, allowing for customization and easy replacement of individual parts. A cover with a slit and fasteners can be fitted over the collar or leash to change its appearance. The system may also include a martingale chain for adjustable tightening or a prong collar element for training purposes. The interchangeable design enables users to create various collar and leash configurations without replacing the entire unit.

### FIELD OF INVENTION

The present disclosure relates to pet accessories, and more particularly to an interchangeable collar and leash system with customizable components and covers.

### BACKGROUND

Pet collars and leashes are essential accessories for pet owners to control and identify their animals. Traditional pet collars and leashes are typically made of leather, nylon, or other durable materials and come in fixed designs and colors. While functional, these standard accessories offer limited options for pet owners who wish to customize or change the appearance of their pet's collar or leash.

In recent years, there has been growing interest among pet owners in personalizing and accessorizing their pets' gear. This trend has led to an increased demand for pet collars and leashes that can be easily customized or changed to suit different occasions, seasons, or owner preferences. However, purchasing multiple complete collar and leash sets can be costly and impractical for many pet owners.

Additionally, traditional pet collars and leashes often have fixed hardware components, such as D-rings, buckles, and snaps, which cannot be easily replaced if damaged or if a different style is desired. This limitation can lead to the need to replace the entire collar or leash sets, even when only a small component requires updating.

Furthermore, some existing pet collars may pose safety concerns, such as the risk of snagging or choking if the collar becomes caught on objects in the pet's environment. There is a need for collar designs that address these safety issues while maintaining functionality and aesthetic appeal.

The pet accessory market continues to evolve, with pet owners seeking products that offer both practicality and style. As such, there is an ongoing need for innovative pet collar and leash systems that provide versatility, customization options, and enhanced safety features to meet the diverse needs and preferences of pet owners and their animals.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, an interchangeable pet accessory system is provided. The system includes a base strap, a plurality of interchangeable hardware components removably attachable to the base strap, and an overlaying strap removably attachable to the base strap. The base strap and overlaying strap are configured to form a pet collar or leash when assembled with the interchangeable hardware components.

According to other aspects of the present disclosure, the system may include one or more of the following features. The interchangeable hardware components may include screws, buckles, snaps, connectors, O-rings, and D-rings. The system may further include a cover removably attachable to the assembled pet collar or leash. The cover may include a slit for accommodating an O-ring or D-ring when attached to a collar. The cover may include fasteners for securing it to the assembled pet collar or leash. The system may include a convertible handle attachable to the base strap, wherein the convertible handle is configurable as a standard handle or a traffic handle. The system may include a Martingale chain or material section attachable to the base strap to form a Martingale-style collar. The system may include an adjustable strap attachable to the Martingale chain or material section. The system may include a prong collar attachable to the base strap and overlaying strap.

According to another aspect of the present disclosure, a method of assembling a pet accessory is provided. The method includes selecting a base strap, selecting a plurality of interchangeable hardware components, attaching the selected interchangeable hardware components to the base strap, selecting an overlaying strap, and attaching the overlaying strap to the base strap to form a pet collar or leash.

According to other aspects of the present disclosure, the method may include one or more of the following features. The method may include selecting and attaching a cover to the assembled pet collar or leash. The method may include configuring a convertible handle as either a standard handle or a traffic handle. The method may include attaching a Martingale chain or material section to the base strap to form a Martingale-style collar. The method may include attaching an adjustable strap to the Martingale chain or material section. The method may include attaching a prong collar to the base strap and overlaying strap.

The foregoing general description of the illustrative embodiments and the following detailed description thereof are merely exemplary aspects of the teachings of this disclosure and are not restrictive.

### BRIEF DESCRIPTION OF FIGURES

FIG. 1A illustrates a top view of an interchangeable collar, according to aspects of the present disclosure.

FIG. 1B depicts a side view of an attachment mechanism for the collar, according to an embodiment.

FIG. 1C presents another view of the collar with a belt loop, according to aspects of the present disclosure.

FIG. 1D shows a close-up view of the attachment mechanism, according to an embodiment.

FIG. 1E illustrates a perspective view of the entire collar and leash system, according to aspects of the present disclosure.

FIG. 2A shows a front view of an interchangeable collar, according to an embodiment.

FIG. 2B presents a rear view of the interchangeable collar, according to aspects of the present disclosure.

FIG. 2C displays an exploded view of the collar components, according to an embodiment.

FIG. 3 illustrates a side view of an interchangeable leash, according to aspects of the present disclosure.

FIG. 4A provides a front view of a collar assembly, according to an embodiment.

FIG. 4B offers a top-down view of the collar assembly, according to aspects of the present disclosure.

FIG. 4C presents another perspective of the collar assembly, according to an embodiment.

FIG. 5A shows a perspective view of an interchangeable martingale animal collar, according to aspects of the present disclosure.

FIG. 5B presents a side view of the martingale collar, according to an embodiment.

FIG. 5C depicts another side view of the martingale collar, according to aspects of the present disclosure.

FIG. 6A shows an exploded view of an interchangeable martingale animal collar, according to an embodiment.

FIG. 6B provides a curved side view of the martingale collar components, according to aspects of the present disclosure.

FIG. 6C presents a three-dimensional view of the assembled martingale collar, according to an embodiment.

FIG. 7A shows an orthogonal view of an interchangeable collar, according to aspects of the present disclosure.

FIG. 7B provides a detailed view of a ring connector assembly, according to an embodiment.

FIG. 8A depicts a cover designed to fit over the collar or leash, according to aspects of the present disclosure.

FIG. 8B illustrates the cover partially installed on a collar, according to an embodiment.

FIG. 9 shows an orthogonal view of a leash configuration, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to an interchangeable pet collar and leash system that offers customization and versatility for pet owners. This system may provide a modular approach to pet accessories, allowing users to create various configurations of collars and leashes using interchangeable components. The system may enable pet owners to modify the appearance, functionality, and fit of their pet's collar or leash without the need to purchase entirely new products. In some cases, the system may include a range of interchangeable straps, hardware, and decorative elements that can be combined in different ways to suit various needs and preferences. The modular nature of the system may allow for easy replacement of individual components, potentially extending the lifespan of the pet accessories. Additionally, the system may offer adaptability for different situations, such as daily walks, training sessions, or special occasions, by allowing quick and simple modifications to the collar or leash configuration.

The interchangeable collar and leash system includes a base strap 1. The base strap 1 may serve as the foundation for both collar and leash configurations. In some cases, the base strap 1 may be made from a durable and flexible material such as nylon, leather, or a synthetic polymer. The material selection for the base strap 1 may provide strength and comfort for the animal wearing the collar or the person holding the leash.

In a collar configuration, the base strap 1 may form the main body of the collar that encircles the animal's neck. The base strap 1 may be designed with a length suitable for various animal sizes, and in some cases, may be adjustable to accommodate different neck circumferences.

For a leash configuration, the base strap 1 may extend to a longer length, providing the primary structure of the leash. The base strap 1 in this configuration may offer sufficient length for controlling and guiding the animal during walks or other activities.

The base strap 1 may include features that enable the attachment of other components, allowing for the interchangeability of the system. In some cases, the base strap 1 may have pre-determined attachment points along its length. These attachment points may facilitate the connection of various accessories, such as rings, buckles, or decorative elements.

The design of the base strap 1 may allow for easy cleaning and maintenance. In some cases, the material of the base strap 1 may be water-resistant or waterproof, enhancing its durability and ease of care.

The base strap 1 may also serve as a platform for customization. Users may be able to select base straps 1 of different colors, patterns, or textures to suit their preferences or to match specific occasions or outfits.

In some implementations, the base strap 1 may incorporate reflective elements or high-visibility materials, enhancing safety during low-light conditions. This feature may be particularly useful for both collar and leash configurations.

The versatility of the base strap 1 may allow it to be used in various animal-related products beyond collars and leashes. For example, the base strap 1 may be incorporated into harnesses, pet carriers, or other pet accessories, maintaining the interchangeable nature of the system across different product types.

The interchangeable collar and leash system may incorporate various fasteners and connectors to enable customization and versatility. In some cases, fasteners 2 may be positioned along the length of the base strap. These fasteners 2 may serve to secure different components of the system together, allowing for easy assembly and disassembly. The fasteners 2 may take various forms, such as screws, snaps, or other suitable attachment mechanisms.

In some implementations, a strap connector 3 may be included in the system. The strap connector 3 may be positioned at one or both ends of the base strap. In some cases, the strap connector 3 may function as a buckle or clasp, allowing the collar to be secured around an animal's neck. The strap connector 3 may also facilitate size adjustment of the collar.

The fasteners 2 and strap connector 3 may work in conjunction to provide a high degree of interchangeability within the system. For example, the fasteners 2 may allow for the attachment and detachment of various components such as overlaying straps, decorative elements, or functional accessories. In some cases, the strap connector 3 may be interchangeable, allowing users to switch between different types of closures or connectors based on preference or specific needs.

The placement of fasteners 2 along the base strap may be strategically determined to maximize flexibility and functionality. In some implementations, multiple fasteners 2 may be evenly spaced along the length of the base strap, providing numerous attachment points for accessories or customization options.

The materials used for the fasteners 2 and strap connector 3 may be selected for durability and ease of use. In some cases, these components may be made from materials resistant to corrosion and wear, ensuring long-term functionality of the interchangeable system.

The interchangeable collar and leash system may include an overlaying strap 4. In some cases, the overlaying strap 4 may be attached to the base strap 1 using fasteners 2. The overlaying strap 4 may serve multiple purposes, including providing additional structural support, allowing for customization of the collar or leash appearance, and enabling functional versatility.

In some implementations, the overlaying strap 4 may be made from a different material or color than the base strap 1, allowing for visual customization of the collar or leash. The overlaying strap 4 may be easily removed and replaced with straps of different designs, patterns, or materials to suit the user's preferences or needs.

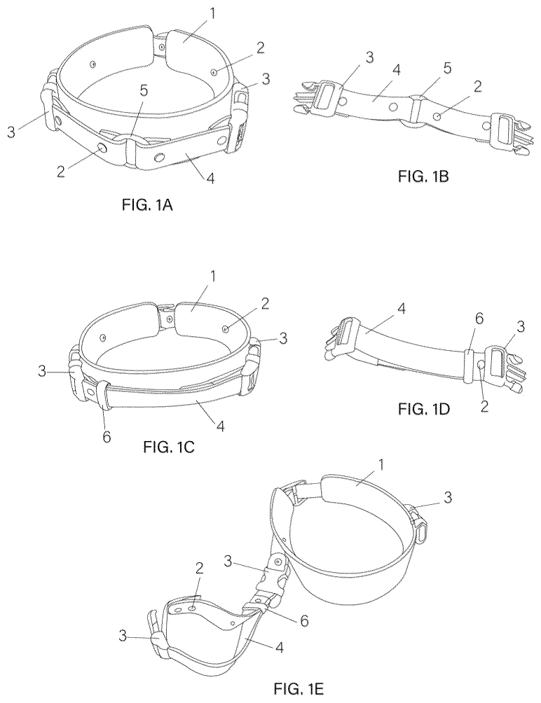

As shown in FIG. 1E, the overlaying strap 4 may also serve functional purposes. In some cases, the overlaying strap 4 may be configured to convert into a handle or traffic handle. This convertible feature may allow for greater control over an animal during walks or in high-traffic areas. To achieve this, the overlaying strap 4 may be designed with additional length or flexibility, allowing it to be manipulated into different shapes or configurations.

For example, the overlaying strap 4 may be folded or looped to create a handle near the collar, providing a convenient grip point for the user. Alternatively, the overlaying strap 4 may be extended to form a short traffic handle, allowing the user to keep the animal close in crowded or potentially dangerous situations.

In some implementations, the overlaying strap 4 may include additional attachment points or features to facilitate its conversion into different functional configurations. These may include loops, fasteners, or adjustable sections that allow the strap to be secured in various positions.

The versatility of the overlaying strap 4 may enhance the overall functionality of the interchangeable collar and leash system, providing users with multiple options for both aesthetic customization and practical use.

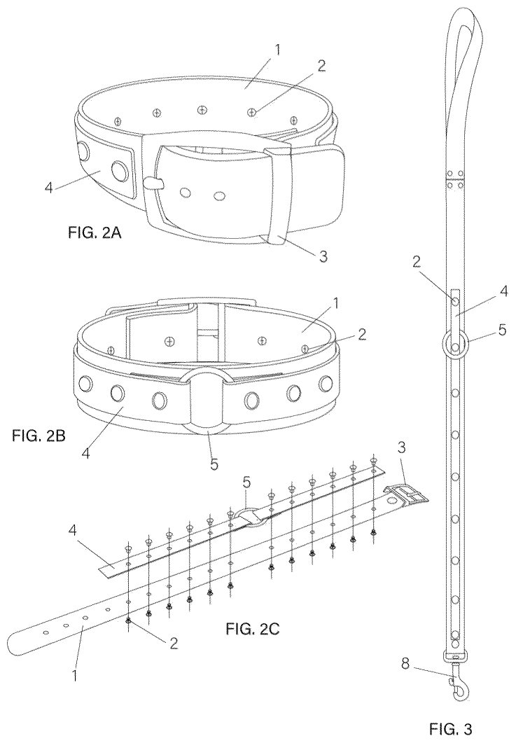

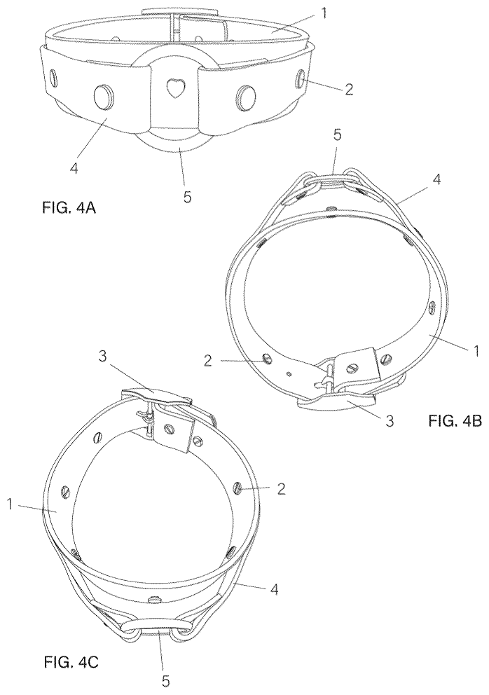

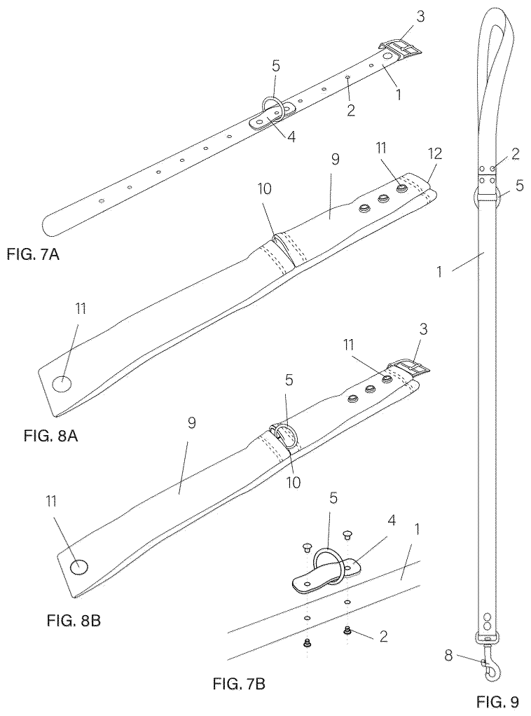

As shown in FIGS. 1A, 1B, 2B, 3, 4A, 4C, 7A, 7B, and 9, in some cases, a ring connector 5 may be included as part of the collar and leash system. The ring connector 5 may be attached to the base strap 1 or overlaying strap 4 of the collar. In some implementations, the ring connector 5 may have a low profile design to minimize potential choking hazards for the animal wearing the collar.

As shown in FIGS. 3 and 9 a leash connector 8 may be incorporated into the leash portion of the system. The leash connector 8 may be positioned at one end of the leash's base strap 1, allowing for attachment to the collar's ring connector 5 or other suitable attachment points.

The ring connector 5 and leash connector 8 may contribute to the system's versatility in several ways. For example, the ring connector 5 on the collar may serve as an attachment point for identification tags, accessories, or the leash itself. In some cases, the ring connector 5 on the leash may be used to secure a cover 9 onto the leash, providing additional customization options.

The placement and design of the ring connector 5 and leash connector 8 may allow for quick and easy attachment and detachment of the leash from the collar, enhancing the system's usability. In some implementations, these connectors may be interchangeable with other types of connectors, further increasing the system's adaptability to different user preferences or needs.

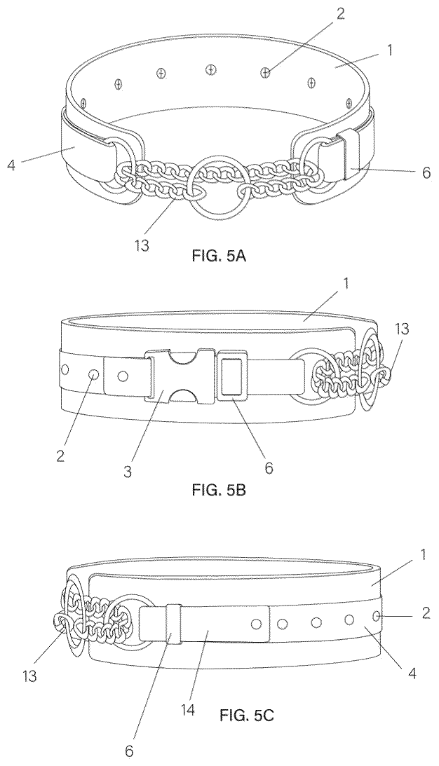

As shown in FIGS. 1C-1E and 5A-5C, in some cases, the interchangeable collar and leash system may include a belt loop 6. The belt loop 6 may be attached to the base strap 1 or the overlaying strap 4. In some implementations, the belt loop 6 may contribute to the system's adjustability by allowing for size adjustments of the collar or leash. The belt loop 6 may provide a means for securing excess strap length or creating a loop for attaching accessories.

The overlaying strap 4 may be configured into various functional forms. In some cases, the overlaying strap 4 may be arranged to form a handle. This handle configuration may provide a convenient grip for controlling an animal during walks. In other implementations, the overlaying strap 4 may be configured into a traffic handle. A traffic handle may be a shorter, more compact handle that allows for close control of an animal in crowded or high-traffic areas.

The versatility of the overlaying strap 4 may allow users to adjust the handle length or configuration based on their specific needs or preferences. In some cases, the handle or traffic handle configuration may be achieved by folding or looping the overlaying strap 4 and securing it with fasteners 2 or other attachment mechanisms.

The belt loop 6 and handle configurations may work in conjunction to enhance the overall functionality and adaptability of the collar and leash system. These features may allow users to customize the system for various situations or animal control requirements.

As shown in FIGS. 8A and 8B, a cover system may include a cover 9 designed to fit over a collar or leash. In some cases, the cover 9 may be used to customize the appearance of the collar or leash without replacing the entire unit. The cover 9 may include a cover slit 10 that allows the cover to accommodate ring connectors or other protruding elements on the collar or leash. A cover opening 12 may be present on the cover 9, enabling the cover to slide over the collar or leash for installation.

In some cases, the cover 9 may be secured in place using cover fasteners 11. The cover fasteners 11 may be positioned at both ends of the cover 9. In some implementations, the cover fasteners 11 may include snaps, Velcro, or magnets. These fastening options may allow for easy attachment and removal of the cover 9, facilitating quick changes in the appearance of the collar or leash.

The cover system may provide a versatile method for altering the look of a collar or leash without the need to replace the entire accessory. This approach may allow pet owners to change the style or color of their pet's accessories to suit different occasions or preferences.

As shown in FIGS. 5A-5C, in some cases, the interchangeable collar system may be configured as a martingale collar. The martingale collar configuration may include a base strap, an overlaying strap, and additional components specific to the martingale design. A martingale chain 13 may be incorporated into the collar structure. The martingale chain 13 may be made from various materials, including metal or fabric-based materials, providing flexibility in design and function.

The martingale collar configuration may include a top strap 14. The top strap 14 may be adjustable, allowing for customization of the collar's fit and function. In some cases, the adjustability of the top strap 14 may enable fine-tuning of the collar's tightening mechanism.

The martingale design may differ from a standard collar configuration in its ability to provide controlled tightening when tension is applied to the leash. This feature may be particularly useful for dogs with narrow heads or those prone to slipping out of traditional collars.

In some implementations, the martingale chain 13 may be interchangeable, allowing for customization of the collar's appearance or function. The martingale chain 13 may connect to the base strap at two points, creating a loop that tightens when pulled.

The adjustable top strap 14 may work in conjunction with the martingale chain 13 to provide a customizable fit. In some cases, the top strap 14 may be adjusted to set the maximum tightness of the collar when tension is applied, ensuring both security and comfort for the animal.

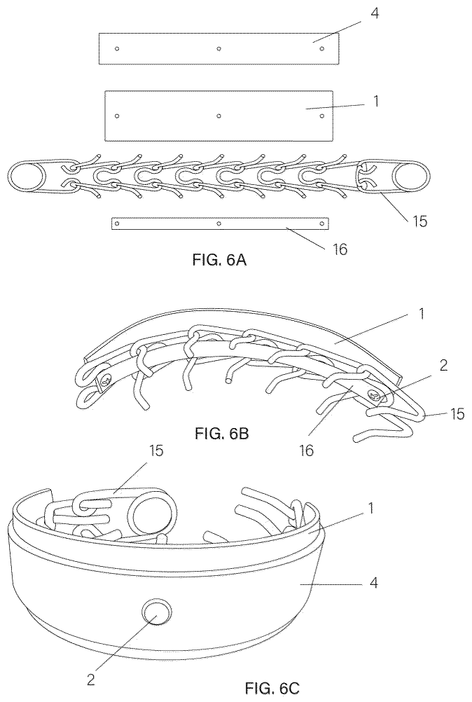

As shown in FIGS. 6A-6C, in some cases, the interchangeable collar system may be integrated with a prong collar 15. A prong collar 15 may be combined with a base strap 1 and an overlaying strap 4 to create a customizable prong collar assembly. The integration of these components allows for the functionality of a prong collar while maintaining the interchangeability and aesthetic options of the base system.

A securing strap 16 may be used to attach the base strap 1 and overlaying strap 4 to the prong collar 15. The securing strap 16 may wrap around the prong collar 15 and connect to the base strap 1 and overlaying strap 4 using fasteners or other attachment mechanisms. This configuration allows for secure attachment while preserving the ability to interchange components as desired.

In some cases, the base strap 1 may be positioned against the inner surface of the prong collar 15, providing a layer of material between the prongs and the animal's neck. The overlaying strap 4 may be placed on the outer surface of the prong collar 15, offering decorative options and additional structural support.

The integration of the prong collar 15 with the interchangeable system may allow users to customize the appearance of the prong collar while maintaining its functionality. Users may change the overlaying strap 4 to alter the collar's appearance without needing to replace the entire prong collar assembly.

The interchangeable pet collar and leash system may integrate various components to provide a customizable and versatile solution for pet owners. In some cases, a base strap may form the foundation of the system, serving as the primary structure for both collars and leashes. Fasteners may be positioned along the base strap, allowing for the attachment and detachment of other components.

A strap connector may be incorporated into the system to secure the collar around a pet's neck or to join different sections of the leash. In some implementations, an overlaying strap may be attached to the base strap, providing additional structural support and aesthetic customization options.

The system may include a ring connector, which may serve multiple purposes such as attaching identification tags, connecting a leash to a collar, or securing accessories. In some cases, a belt loop may be integrated into the design, allowing for size adjustments or creating handle configurations.

For enhanced functionality, a top strap 14 may be incorporated into certain collar designs, such as martingale-style collars. A leash connector may be included to facilitate the attachment of a leash to a collar or to create various leash configurations.

The system may also feature a cover that can be applied over the collar or leash to change its appearance. In some implementations, the cover may include a cover slit to accommodate ring connectors or other protruding elements. Cover fasteners may be used to secure the cover in place, while a cover opening may allow for easy installation and removal of the cover.

For specialized collar types, the system may incorporate a martingale chain 13, providing controlled tightening for certain breeds. In some cases, a prong collar 15 may be integrated into the system, with a securing strap to attach it to the base strap.

The modular nature of the system may allow pet owners to customize their pet's collar or leash by interchanging components. For example, the base strap may be combined with different overlaying straps, ring connectors, and covers to create unique designs. The fasteners may facilitate easy assembly and disassembly, enabling quick changes to the collar or leash configuration.

In some implementations, the system may allow for conversion between collar and leash functionalities. For instance, a collar may be transformed into a short leash by adjusting the overlaying strap or utilizing the belt loop as a handle.

The versatility of the system may extend to accommodating different collar styles, such as standard flat collars, martingale collars, or prong collars, all while maintaining the ability to customize appearance and functionality through interchangeable components.

A number of implementations have been described. Nevertheless, it will be understood that various modifications may be made without departing from the spirit and scope of the disclosure. Accordingly, other implementations are within the scope of the following claims.

1. An interchangeable pet accessory system, comprising:
a base strap;
a plurality of interchangeable hardware components removably attachable to the base strap; and
an overlaying strap removably attachable to the base strap, wherein the base strap and overlaying strap are configured to form a pet collar or leash when assembled with the interchangeable hardware components.

2. The interchangeable pet accessory system of claim 1, wherein the interchangeable hardware components comprise at least one of: screws, buckles, snaps, connectors, O-rings, and D-rings.

3. The interchangeable pet accessory system of claim 1, further comprising a cover removably attachable to the assembled pet collar or leash.

4. The interchangeable pet accessory system of claim 3, wherein the cover comprises a slit for accommodating an O-ring or D-ring when attached to the pet collar.

5. The interchangeable pet accessory system of claim 1, wherein the overlaying strap can be disconnected on one side to define a convertible handle attachable to the base strap, wherein the convertible handle is configurable as a standard handle or a leash.

6. The interchangeable pet accessory system of claim 1, further comprising a Martingale chain or material section attachable to the base strap to form a Martingale-style collar.

7. The interchangeable pet accessory system of claim 6, further comprising an adjustable strap attachable to the Martingale chain or material section.

8. A method of assembling a pet accessory, comprising:
selecting a base strap;
selecting a plurality of interchangeable hardware components;
attaching the selected interchangeable hardware components to the base strap;
selecting an overlaying strap; and
attaching the overlaying strap to the base strap to form a pet collar or leash.

9. The method of claim 8, wherein the interchangeable hardware components comprise at least one of: screws, buckles, snaps, connectors, O-rings, and D-rings.

10. The method of claim 8, further comprising selecting and attaching a cover to the assembled pet collar or leash.

11. The method of claim 10, wherein the cover comprises a slit for accommodating an O-ring or D-ring when attached to the pet collar.

12. The method of claim 8, further comprising configuring the overlaying strap as a convertible handle as either a standard handle or a leash.

13. The method of claim 8, further comprising attaching a Martingale chain or material section to the base strap to form a Martingale-style collar.

14. The method of claim 13, further comprising attaching an adjustable strap to the Martingale chain or material section.

15. A customizable pet collar, comprising:
a base strap;
a plurality of fasteners arranged along the base strap;
an overlaying strap removably attachable to the base strap via the fasteners; and
at least one interchangeable hardware component removably attachable to at least one of the base strap and the overlaying strap.

16. The customizable pet collar of claim 15, wherein the interchangeable hardware component comprises at least one of: a buckle, a snap, an O-ring, and a D-ring.

17. The customizable pet collar of claim 15, further comprising a cover removably attachable to the assembled pet collar.

18. The customizable pet collar of claim 17, wherein the cover comprises a slit for accommodating the interchangeable hardware component when attached to the pet collar.

19. The customizable pet collar of claim 15, wherein the base strap and the overlaying strap are made of different materials.

20. The customizable pet collar of claim 19, wherein the overlaying strap comprises a decorative pattern or design.
